(19) United States
(12) Patent Application Publication
(10) Pub. No.: US 2026/0173057 A1
(43) Pub. Date: Jun. 18, 2026

(54) BANDWIDTH PART SWITCH CONFIGURATION

(71) Applicant: QUALCOMM Incorporated, San Diego, CA (US)

(72) Inventors: Diana MAAMARI, San Diego, CA (US); Gabi SARKIS, San Diego, CA (US); Chun-Hao HSU, San Jose, CA (US); Jae Ho RYU, San Diego, CA (US)

(21) Appl. No.: 18/981,268

(22) Filed: Dec. 13, 2024

(51) Int. Cl. H04W 72/0457; H04W 72/51

(52) U.S. Cl. CPC H04W 72/0457; H04W 72/51

(57) ABSTRACT

Certain aspects of the present disclosure provide techniques for wireless communications. An example method includes sending, to a network entity, an indication of a first capability relating to a first switching delay associated with a first set of configurations and a second capability relating to a second switching delay associated with a second set of configurations, wherein the first switching delay and the second switching delay are associated with a bandwidth part (BWP) switch and the first switching delay is shorter than the second switching delay; and performing the BWP switch in accordance with the first switching delay or the second switching delay.

### INTRODUCTION

### Field of the Disclosure

Aspects of the present disclosure relate to wireless communications, and more particularly, to techniques for bandwidth part (BWP) switch configuration.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment. The method includes sending, to a network entity, an indication of a first capability relating to a first switching delay associated with a first set of configurations and a second capability relating to a second switching delay associated with a second set of configurations, wherein the first switching delay and the second switching delay are associated with a BWP switch and the first switching delay is shorter than the second switching delay; and performing the BWP switch in accordance with the first switching delay or the second switching delay.

Certain aspects provide a method for wireless communications by a network entity. The method includes sending a query regarding a plurality of configurations relating to a BWP switch; and obtaining an indication of a first capability relating to a first switching delay associated with a first set of configurations and a second capability relating to a second switching delay associated with a second set of configurations, wherein the first switching delay and the second switching delay are associated with the BWP switch and the first switching delay is shorter than the second switching delay.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example of a plurality of bandwidth parts (BWPs).

FIGS. 5B and 5C depict examples of BWP configurations.

FIGS. 6A and 6B depict examples of a BWP switch.

FIG. 7 depicts a process flow for communications in a network between a user equipment and a network entity.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for bandwidth part (BWP) switch configuration.

Certain wireless communications systems, such as 5G New Radio (NR) systems and/or future wireless communications technologies, allow a user equipment to use a subset of a carrier bandwidth as a way to save power and increase flexibility of configuration. For example, the user equipment may use one or more BWPs for wireless communication, rather than a whole carrier bandwidth. A BWP is a contiguous set of resource blocks (RBs) and a subset of a carrier bandwidth, where each RB covers 12 consecutive subcarriers in the frequency domain. One or more BWPs (e.g., up to 4 BWPs) may be configured for the user equipment, and one of these BWPs (encompassing a subset of a carrier bandwidth) may be subsequently activated for communication. Monitoring only the subset of the carrier bandwidth may allow the user equipment to save power based on, for example, the reduced amount of radio frequency (RF) and baseband signal processing, when compared to monitoring the whole carrier bandwidth.

Activating a BWP for a user equipment may involve changing RF and/or baseband configurations on the user equipment to receive or transmit with the BWP. Activating the BWP may be referred to herein as a BWP switch. A BWP switch can include switching from a first BWP to a second BWP, or initiating communication on a BWP. Technical problems for such BWP switching may include, for example, having too many configurations that are BWP dependent. For example, a user equipment may either (1) store all BWP configurations such as RF and/or bandwidth configurations, or (2) reprogram RF and/or bandwidth configuration for each BWP switch. Storing all configurations may take up more than a desired amount of memory on the user equipment, while reprogramming the RF and/or bandwidth configurations for each BWP switch may cause more than a desired amount of latency for the BWP switch. As the user equipment is not required to transmit or receive data during the BWP switch, an increased latency for the BWP switch may result in a reduced data throughput. On the other hand, the increased memory involved in storing all configurations may increase cost and complexity of the user equipment.

Aspects described herein may provide a way to define a BWP switch more precisely while still allowing flexibility at the network side to tailor the BWP configurations as needed. In certain aspects, defining the BWP switch more precisely allows the latency for the BWP switch to be optimized. The latency for the BWP switch may be referred to herein as a switching delay. In certain aspects, a user equipment may send, to a network entity, an indication of a first capability relating to a first switching delay associated with a first set of configurations and a second capability relating to a second switching delay associated with a second set of configurations. In certain aspects, the first switching delay may be shorter than the second switching delay. The first switching delay and the second switching delay may be associated with a BWP switch, and the user equipment may perform the BWP switch in accordance with the first switching delay or the second switching delay. Accordingly, a BWP switching timeline may be defined more precisely in view of a set of configurations that the user equipment may be switching to (such as based on an impact of the set of configurations on the BWP switching timeline in view of complexity associated with the set of configurations), and optionally of another set of configurations that the user equipment may be switching from.

Certain techniques for defining the BWP switch more precisely as described herein may provide various beneficial technical effects and/or advantages. The techniques for defining the BWP switch more precisely may enable improved wireless communications performance, such as reduced latency associated with the BWP switch, resulting in an increased data throughput. The improved wireless communications performance, such as the increased data throughput, may be attributable to the reduced switching delay associated with the BWP switch as described herein, for example, due to relevant configurations for the BWP switch being defined more precisely.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

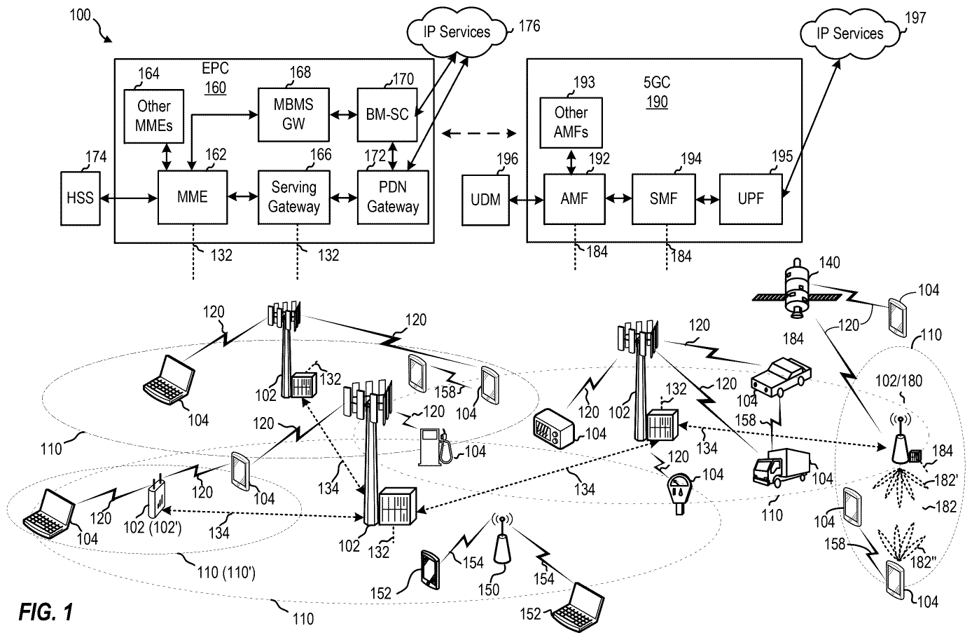

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140). In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

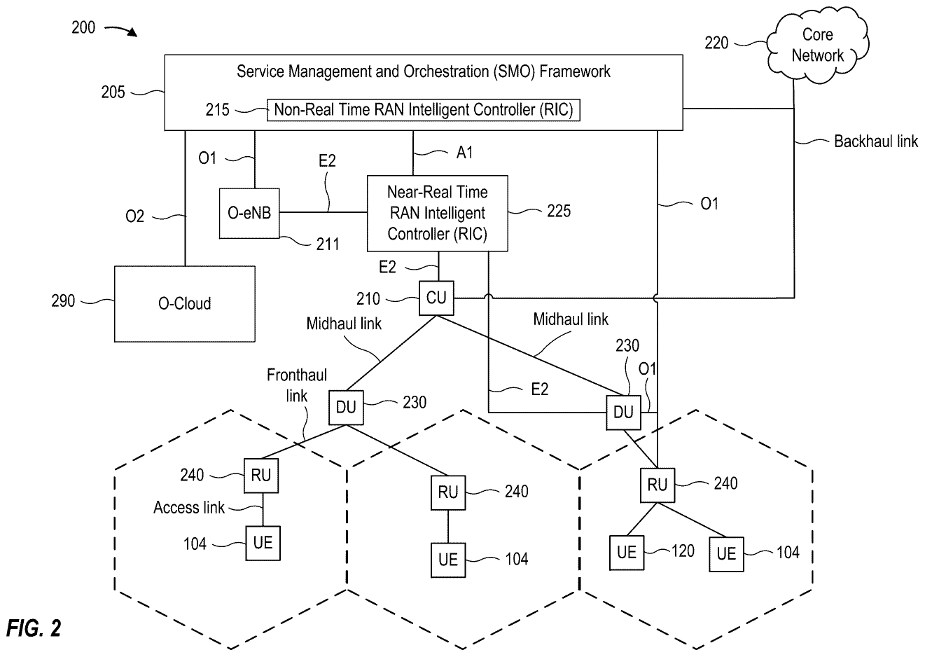

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mm Wave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

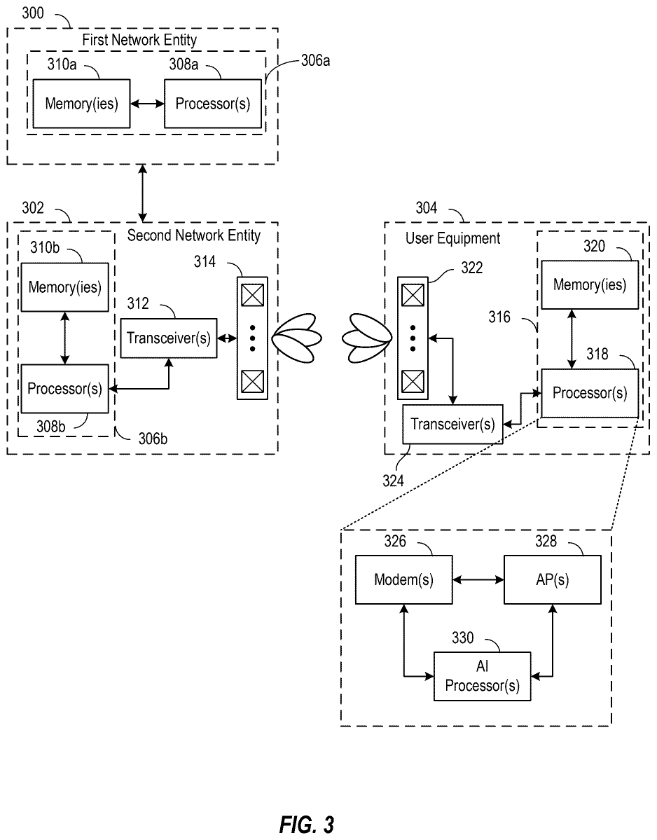

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

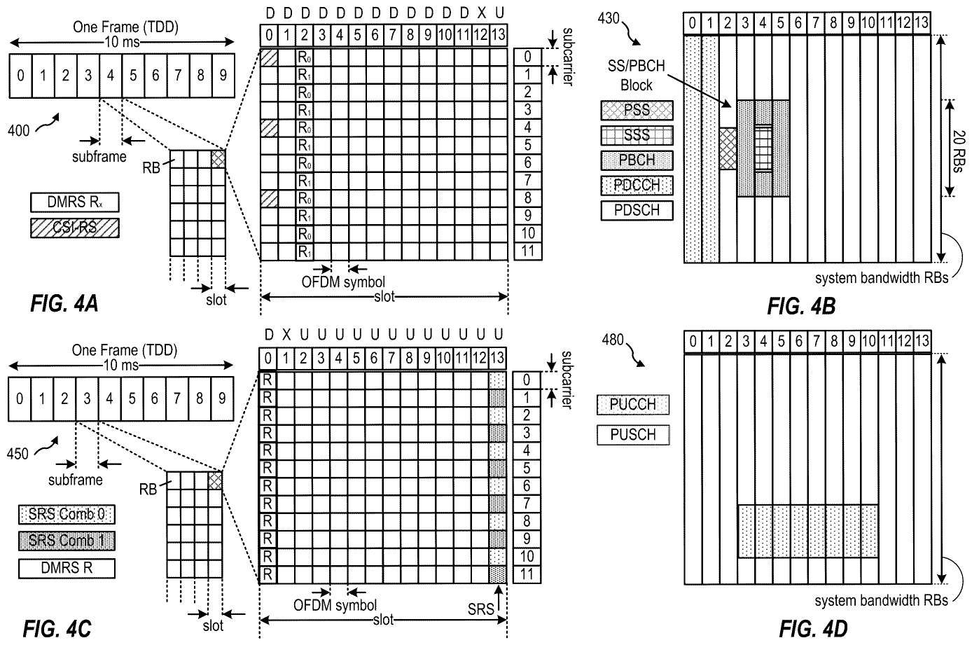

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Bandwidth Parts and Bandwidth Part Switching

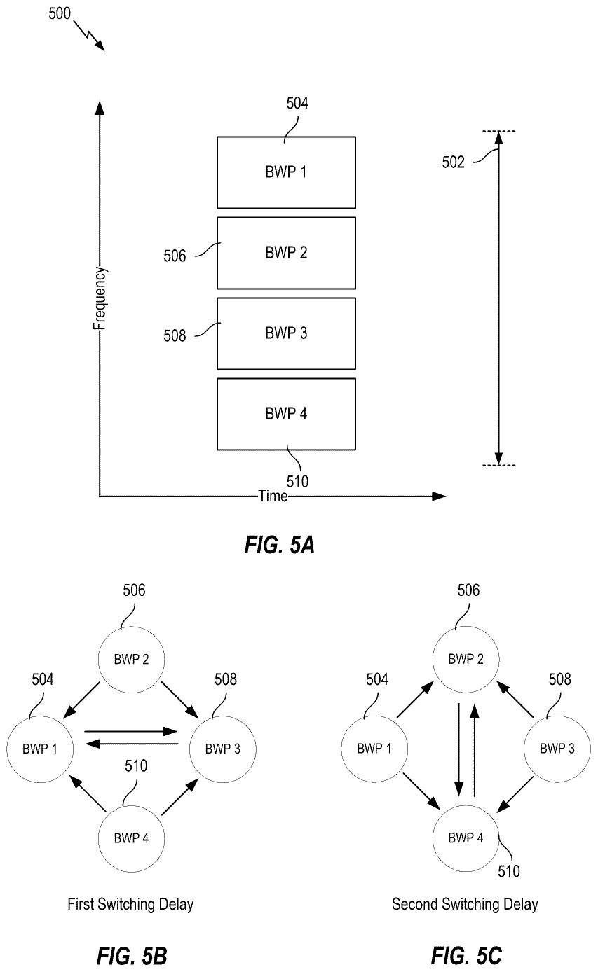

FIG. 5A depicts an example 500 of BWPs. As depicted, a BWP is a subset of a carrier bandwidth 502. In certain aspects, multiple, such as up to a maximum of four, BWPs can be defined in the downlink (DL) and the uplink (UL). First BWP 504, second BWP 506, third BWP 508, and fourth BWP 510 are depicted in FIG. 5A. For FDD, timeline for the BWP switch described herein can be specific to DL or UL. For TDD, when the network indicates a BWP switch, a BWP may be switched for both DL and UL. While first BWP 504, second BWP 506, third BWP 508, and fourth BWP 510 are depicted in FIG. 5A as being configured as non-overlapped and of equal bandwidth, in some aspects, two BWPs may have different bandwidths and/or be overlapped. Amongst the defined BWPs, only one BWP may be active at a given moment in the DL, and only one BWP may be active at a given moment in the UL. For example, a user equipment does not expect any data or information on a PDSCH, a PDCCH, or a CSI-RS outside the active DL BWP (and there may be only one active DL BWP). Moreover, the user equipment does not send any data or information on PUSCH, PUCCH, or SRS outside the active UL BWP (and there may be only one active UL BWP). In certain aspects, a BWP switch may be performed by one of several different ways. For example, a BWP switch can be triggered using PDCCH such as DCI, where a specific BWP can be activated by a BWP indicator in DCI Format 0_1 (for UL) and DCI Format 1_0 (for DL). As another example, a BWP switch can be triggered by a BWP inactivity timer. As another example, a BWP switch can be triggered by RRC signaling. As another example, a BWP switch can be triggered by a UE's MAC entity itself upon initiation of a random access procedure.

As described herein, in certain aspects, certain BWP(s) may be configured as a first BWP type and certain other BWP(s) may be configured as a second BWP type. In certain aspects, the first BWP type of BWP(s) may be referred to as “fast” BWP(s) or first BWPs and the second BWP type of BWP(s) may be referred to as “regular” or “slow” BWP(s) or second BWPs. In certain aspects, the first BWP(s) may be associated with a first switching delay and the second BWP(s) may be associated with a second switching delay, where the first switching delay is shorter than the second switching delay. The first switching delay and the second switching delay may be defined by a number of slots, which may be translated to time, for example in milliseconds (ms), based on the associated slot length. For example, the slot length is a duration of time corresponding to each slot, based on the associated subcarrier spacing (SCS).

Whether a BWP may be the first BWP type or the second BWP type may depend on user equipment capability, as described elsewhere herein. Moreover, the switching delay associated with the first BWP type and the second BWP type may be based on a plurality of configurations associated with the BWP. For example, each BWP may be associated with certain configurations that affect how quickly a user equipment can switch to or from each BWP. In certain aspects, examples of configurations for DL BWPs may be related to performing or receiving data or information via PDCCH, PDSCH, DL semi-persistent scheduling (SPS), radio link monitoring (RLM), etc. Examples of configurations for UL BWP may be related to performing or receiving data or information via random access channel (RACH), PUCCH, PUSCH, SRS, UL configured grant (CG), beam failure recovery (BFR), etc. Other examples of configurations that can affect a timeline for switching between BWPs include whether or not channel state feedback can be maintained through the BWP switch, whether a source BWP and a target BWP have a same SCS, or whether the BWP switch is a cross-carrier BWP switch.

Aspects described herein provide for indication, by the user equipment, of a capability associated with a BWP switch associated with a plurality of configurations (such as the configurations above). For example, the capability may indicate a BWP switching timeline or delay associated with the plurality of configurations.

As depicted in FIGS. 5B and 5C, an example configuration of first BWP 504, second BWP 506, third BWP 508, and fourth BWP 510 may be that first BWP 504 and third BWP 508 are first (fast) BWPs and second BWP 506 and fourth BWP 510 are second (regular/slow) BWPs. For example, switching to first BWP 504 or third BWP 508 from another BWP, as illustrated in FIG. 5B, may result in the first switching delay. Switching to second BWP 506 or fourth BWP 510 from another BWP, as illustrated in FIG. 5C, may result in the second switching delay. The user equipment is not required to transmit or receive data during the switching delay. Thus, the user equipment may not monitor or communicate on any BWP during the period of time corresponding to the switching delay.

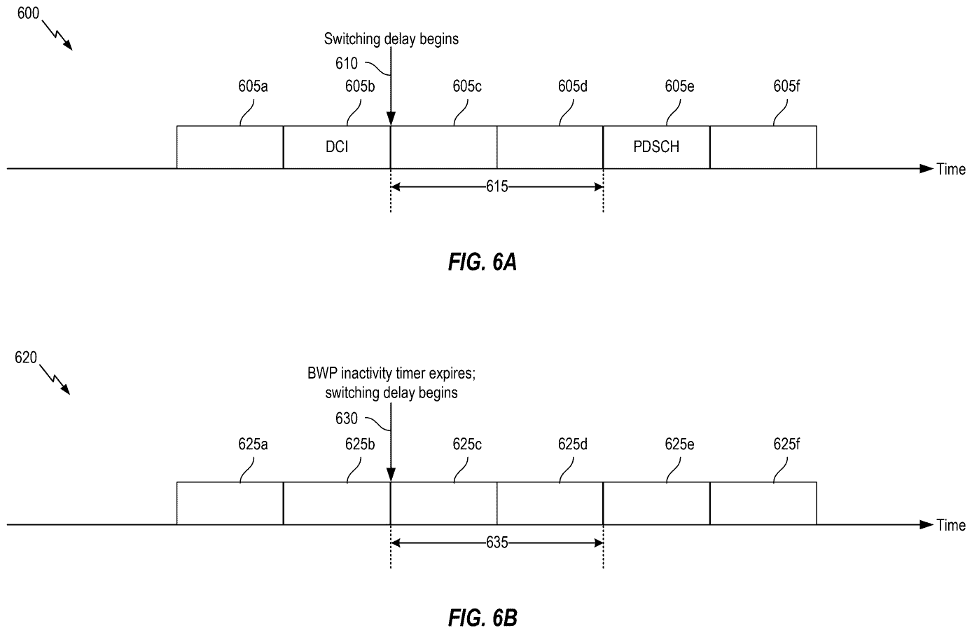

FIGS. 6A and 6B depict examples of a BWP switch. Particularly, FIGS. 6A and 6B depict example timelines 600 and 620 of a BWP switch. Example timeline 600 of FIG. 6A depicts a first timeline associated with a DCI-based BWP switch. Example timeline 620 of FIG. 6B depicts a second timeline associated with a timer-based BWP switch.

As depicted in FIG. 6A, example timeline 600 for the DCI-based BWP switch includes slots 605a-f. In slot 605b, a DCI indicating a BWP switch for a new BWP may be received at a user equipment. Accordingly, a switching delay 615 begins at 610. The user equipment may be able to receive PDSCH or transmit PUSCH on the new BWP starting in slot 605e. That is, the user equipment may not transmit or receive (depending on whether the BWP is a downlink BWP or an uplink BWP) any data or information during the switching delay 615, which spans slots 605c and 605d in the example shown in FIG. 6A.

As depicted in FIG. 6B, example timeline 620 for the timer-based BWP switch includes slots 625a-f. After slot 625b, the timer (BWP inactivity timer) for a previous active BWP may expire at 630, at which point in time a switching delay 635 may begin. The BWP inactivity timer may be configured by a network entity. The user equipment may be able to receive PDSCH or transmit PUSCH on a new BWP, such as a default BWP, starting in slot 625e. That is, the user equipment may not transmit or receive (depending on whether the BWP is a downlink BWP or an uplink BWP) any data or information during the switching delay 635, which spans slots 625c and 625d in the example shown in FIG. 6B.

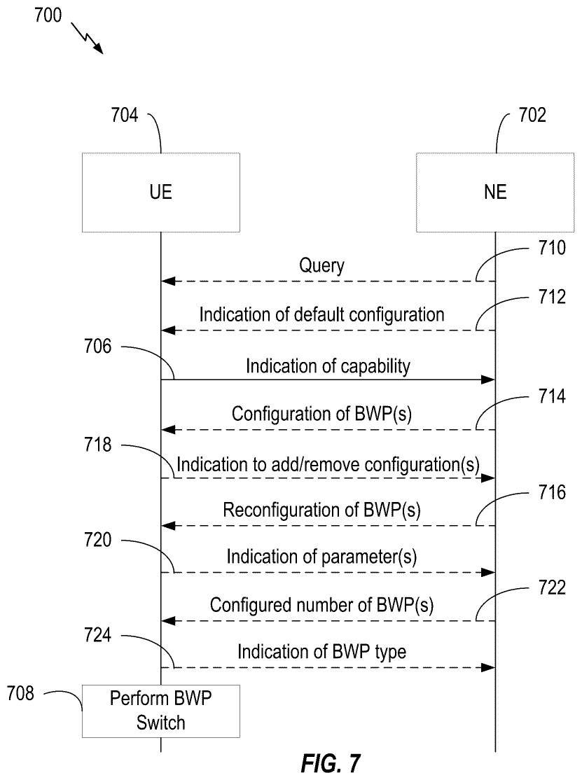

In certain aspects, the switching delay 615 and the switching delay 635 depicted in FIGS. 6A and 6B, respectively, may be based on a capability associated with the new BWP's plurality of configurations, as described in connection with FIG. 7.

### Example Signaling of BWP Switch Configuration

FIG. 7 depicts a process flow 700 for communications in a network between a network entity (illustrated as “NE”) 702 and a user equipment (UE) 704. In some aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

In the description of the process flow 700, an indication of a capability (at 706) and BWP switching in accordance with the capability (at 708) are first introduced. Then, certain other signaling is described. In some instances, the other signaling may occur before the indication of the capability or the BWP switching.

At 706, UE 704 sends, to network entity 702, an indication of a first capability relating to a first switching delay associated with a first set of configurations and a second capability relating to a second switching delay associated with a second set of configurations. More generally, the UE 704 may send an indication of a plurality of capabilities, each capability relating to a respective switching delay and associated with a respective set of configurations. In certain aspects, the first switching delay and the second switching delay may each be a switching delay indicated in terms of a number of slots. The switching delay may be related to one or more configurations of the first set of configurations or the second set of configurations. In certain aspects, the first switching delay and the second switching delay are associated with a BWP switch described herein, where the first switching delay is shorter than the second switching delay. In certain aspects, the indication of a capability may include one or more combinations of configurations associated with the BWP switch. In certain aspects, the first switching delay may be associated with a fast BWP described herein with respect to FIGS. 5A, 5B, and 5C, while the second switching delay may be associated with a regular/slow BWP described herein with respect to FIGS. 5A, 5B, and 5C. In some aspects, the UE 704 may provide the indication as part of UE capability signaling.

Each set of configurations, of the first set of configurations and the second set of configurations, may include one or more configurations that may affect a switching time between BWPs. If the first switching delay is shorter than the second switching delay, for example, this may be because the first set of configurations are configured such that the UE takes less time to reconfigure to a BWP with the first set of configurations than the UE takes to reconfigure to a BWP with the second set of configurations. In some examples, the first set of configurations may include a configuration with which the UE 704 does not need to perform an RF retuning, whereas the second set of configurations may include a configuration with which the UE 704 has to perform an RF retuning. In such examples, the first capability may indicate a first, shorter switching delay and the second capability may indicate a second, longer switching delay.

As an example, the UE 704 may provide capabilities relating to one or more of four sets of configurations. An example four sets of configurations are illustrated in Table 1, though it should be understood that the UE 704 can provide capabilities relating to any number of sets of configurations (including, potentially, up to all combinations of configurations that can be configured for a BWP for the UE 704). In Table 1, a leftmost column indicates an index of a set of configurations, a rightmost column indicates a switching delay associated with the corresponding set of configurations, and the second, third, fourth, and fifth columns indicate configurations or information elements (IEs) of each set of configurations:

TABLE 1

| | | | Same | BWP | |
|---|---|---|---|---|---|
| | Configuration | | SCS | switched | |
| Combi- | that requires | CSF | across | across | Switching |
| nation | RF tune | Assumption | BWP | CCs | Delay |
| 1 | No | Maintained | Yes | No | 1 slot |
| | | across BWP | | | |
| 2 | No | Not | Yes | No | 2 slots |
| | | Maintained | | | |
| | | across BWP | | | |
| 3 | Yes | Not | No | Yes | 5 slots |
| | | Maintained | | | |
| | | across BWP | | | |
| 4 | No | Maintained | Yes | Yes | 2 slots |
| | | across BWP | | | |

In Table 1, for example, a first set of configurations (associated with index 1) does not require an RF tuning, has CSF maintained across a BWP switch, has the same SCS across the BWP switch, and does not involve cross-component-carrier (CC) switching. Thus, this first set of configurations is associated with a capability indicating a switching delay of 1 slot (a shortest switching delay of Table 1). A third set of configurations (associated with index 3) requires an RF tuning, does not have CSF maintained across a BWP switch, does not have the same SCS across the BWP switch, and involves cross-CC switching (e.g., switching across CCs or sub-bands, rather than switching within an anchor cell or primary cell). Thus, this third set of configurations is associated with a capability indicating a switching delay of 5 slots (a longest switching delay of Table 1). In some aspects, the switching delay or capability may be based on whether a given IE or configuration is configured for a BWP. For example, a first switching delay may be used when the given IE or configuration is configured for a BWP, and a second switching delay may be used when the given IE or configuration is not configured for the BWP.

Other examples of configurations that may be configured (such as in Table 1, or for a BWP) and that may affect a switching time of a BWP include a physical random access channel configuration, a channel state information reference signal configuration, a physical downlink control channel configuration, an SPS configuration, or a CG configuration.

At 708, UE 704 performs the BWP switch in accordance with the first switching delay or the second switching delay. For example, UE 704 may perform the BWP switch in accordance with the first switching delay or the second switching delay based on the combination of configurations that UE 704 is capable of. In certain aspects, the performance of the BWP switch may be based on whether the BWP switch is associated with an immediate channel state information (CSI) feedback after the BWP switch. For example, the UE 704 may perform the BWP switch in accordance with a first timeline if immediate CSI feedback is configured, and may perform the BWP switch in accordance with a second timeline if immediate CSI feedback is not configured.

In certain aspects, UE 704 may receive, from network entity 702, a query regarding a plurality of configurations, at 710. In some aspects, the query may indicate a set of configurations (such as one or more of the sets of configurations illustrated in Table 1, or one or more combinations of the configurations illustrated in Table 1). The query may request that the UE 704 provide a capability (e.g., switching delay) for the indicated set of configurations. In certain aspects, UE 704 may send the indication from 706 in response to the query regarding the plurality of configurations.

In certain aspects, UE 704 may obtain, from network entity 702, a second indication of at least one configuration of the plurality of configurations as a default configuration of the BWP switch, at 712. For example, the default configuration may be one or more configurations to be configured as a default set of configurations of the BWP switch, where the default set of configurations may be associated with a certain switching delay. In certain aspects, the indication at 706 may relate to one or more additional configurations of the plurality of configurations other than the at least one configuration from 712 (the default configuration), and the indication at 706 may be sent by UE 704 based on the one or more additional configurations being excluded from the default configuration. Thus, the network entity 702 may signal default BWP configuration(s) that will be configured as part of a BWP configuration, and any additional configuration for a BWP may be negotiated with the UE 704 (such that the network entity 702 is aware of the impact on switching delay of configuring the additional configuration for the BWP). In certain aspects, the operations at 712 may be performed before the operations at 706.

In certain aspects, the indication at 706 may indicate a maximum number of BWPs that can be a first BWP type. In some aspects, UE 704 may also signal a number of supported BWPs of a second BWP type. The first BWP type may be associated with the first BWP switching delay, while the second BWP switching delay may be associated with the second BWP type. In certain aspects, UE 704 may obtain, from network entity 702, a configuration of one or more BWPs of the first type, at 714. The number of the one or more BWPs configured as the first type may be less than or equal to the maximum number of BWPs indicated in the indication from 706. In certain aspects, the configuration from 714 may configure one or more other BWPs as the second type, and UE 704 may obtain, from network entity 702, a reconfiguration of at least one BWP of the one or more BWPs of the first type or the one or more other BWPs of the second type, at 716. In certain aspects, the reconfiguration may be done by a MAC control element (CE) or a RRC signaling.

In certain aspects, UE 704 may send, to network entity 702, a second indication to add or remove one or more configurations to or from the BWP switch, at 718. In certain aspects, the second indication to add or remove may be part of a capability information and/or assistance information. In some aspects, as part of UE capability signaling or UE assistance information, the UE 704 may indicate one or more configurations (such as one or more configurations of Table 1 or another configuration) that are permitted to be configured in a BWP. For example, the UE 704 may indicate one or more supported or unsupported configurations that the UE 704 can or cannot be configured with. As another example, the UE 704 may request that one or more configurations be added to or removed from a list of available configurations. The network entity 702 may negotiate with the UE 704 regarding adding or removing (e.g., availability of) one or more configurations, and the UE 704 may respond to these negotiations as part of UE capability signaling or UE assistance information.

In certain aspects, UE 704 may send, to network entity 702, a second indication of one or more configurations associated with causing a BWP to be of the first type or the second type, at 720. For example, UE 704 may indicate in the second indication which set(s) of configurations (such as values of configurations identified in Table 1) would cause the BWP to be associated with a given switching delay or to be considered a fast BWP or a regular/slow BWP. In certain aspects, this second indication may be sent as part of a capability information or assistance information. In certain aspects, the configurations may be referred to as parameters, and these two terms (configurations and parameters) may be used interchangeably in this context.

In certain aspects, UE 704 may obtain, from network entity 702, a configuration of a configured number of BWPs, at 722. Moreover, UE 704 may send, to network entity 702, a second indication of at least a first BWP of the configured number of BWPs as being of a first type or a second type. For example, the first type may be associated with the first switching delay and the second type may be associated with the second switching delay. For example, the network can send an indication of a number of BWPs (or a respective set of configurations for each of the number of BWPs) to UE 704, and UE 704 can indicate whether each of the BWP(s) is/are fast or regular/slow or can indicate a switching delay associated with each of the BWP(s).

In certain embodiments, the BWP switch of 708 may include a change in RF bandwidth and no change in a baseband configuration. For example, bandwidth adaptation can be defined in a way where all baseband configurations remain unchanged while only RF bandwidth is adapted. Accordingly, the BWP switch may be light-weight/fast and thus can be triggered more dynamically depending on traffic demand.

Note that the process flow illustrated in FIG. 7 is an example of the BWP switch configuration described herein, and aspects of the present disclosure may be applied to the BWP switch configuration. Note that the process flow illustrated in FIG. 7 is described herein to facilitate an understanding of the BWP switch configuration, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Operations of a User Equipment

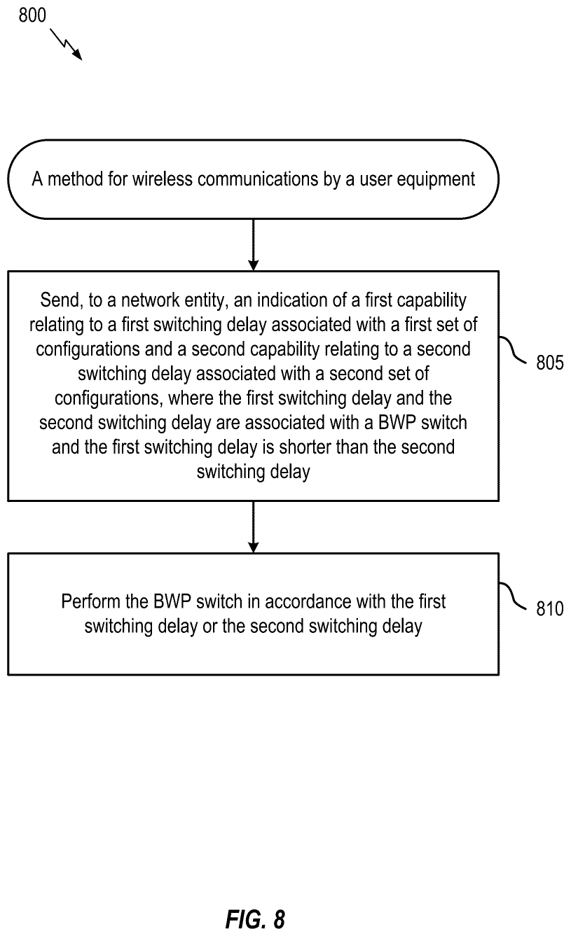

FIG. 8 shows a method 800 for wireless communications by an apparatus, such as UE 104 of FIG. 1 or UE 304 of FIG. 3.

Method 800 begins at block 805 with sending, to a network entity, an indication of a first capability relating to a first switching delay associated with a first set of configurations and a second capability relating to a second switching delay associated with a second set of configurations, where the first switching delay and the second switching delay are associated with a BWP switch and the first switching delay is shorter than the second switching delay. For example, the first switching delay and the second switching delay may correspond to the switching delay 615 and the switching delay 635 depicted in and described in connection with FIGS. 6A and 6B, respectively. Moreover, in certain aspects, block 805 corresponds to the UE 704 sending, to network entity 702, an indication of a first capability relating to a first switching delay associated with a first set of configurations and a second capability relating to a second switching delay associated with a second set of configurations, as described herein in connection with 706 of FIG. 7.

Method 800 then proceeds to block 810 with performing the BWP switch in accordance with the first switching delay or the second switching delay. In certain aspects, block 810 corresponds to the UE 704 performing a BWP switch in accordance with a first switching delay or a second switching delay, as described herein in connection with 708 of FIG. 7.

In some aspects, method 800 further includes receiving, from the network entity, a query regarding a plurality of configurations; and where block 805 includes sending the indication in response to the query regarding the plurality of configurations.

In some aspects, the indication comprises a switching delay relating to one or more configurations of the first set of configurations or the second set of configurations.

In some aspects, the performance of the BWP switch is based on whether the BWP switch is associated with an immediate CSI feedback after the BWP switch.

In some aspects, the indication is a first indication and method 800 further includes sending, to the network entity, a second indication to add or remove one or more configurations to or from the BWP switch as part of at least one of a capability information or assistance information.

In some aspects, the indication is a first indication and method 800 further includes obtaining, from the network entity, a second indication of at least one configuration as a default configuration of the BWP switch.

In some aspects, the indication relates to one or more additional configurations other than the at least one configuration, where block 805 includes sending the indication based on the one or more additional configurations being excluded from the default configuration.

In some aspects, the indication indicates a maximum number of BWPs that can be a first BWP type. The maximum number of BWPs are associated with the BWP switch. Moreover, the first BWP type is associated with the first switching delay. Furthermore, the second switching delay is associated with a second BWP type. Additionally, the method 800 further comprises obtaining a configuration of one or more BWPs of the first BWP type, where a number of the one or more BWPs configured as the first BWP type is less than or equal to the maximum number of BWPs indicated in the indication.

In some aspects, the configuration configures one or more other BWPs as the second BWP type, and the method 800 further comprises obtaining a reconfiguration of at least one BWP of the one or more BWPs of the first BWP type or the one or more other BWPs of the second BWP type by a MAC CE or a RRC signaling.

In some aspects, the indication is a first indication and the method 800 further comprises sending a second indication of one or more parameters associated with causing a BWP to be of the first BWP type or the second BWP type, where the second indication is sent as part of a capability information or assistance information.

In some aspects, the indication is a first indication and the method 800 further comprises obtaining, from the network entity, a configuration of a configured number of BWPs; and sending, to the network entity, a second indication of at least a first BWP of the configured number of BWPs as being of a first BWP type or a second BWP type, where the first BWP type is associated with the first switching delay and the second BWP type is associated with the second switching delay.

In some aspects, the BWP switch comprises a change in RF bandwidth and no change in a baseband configuration.

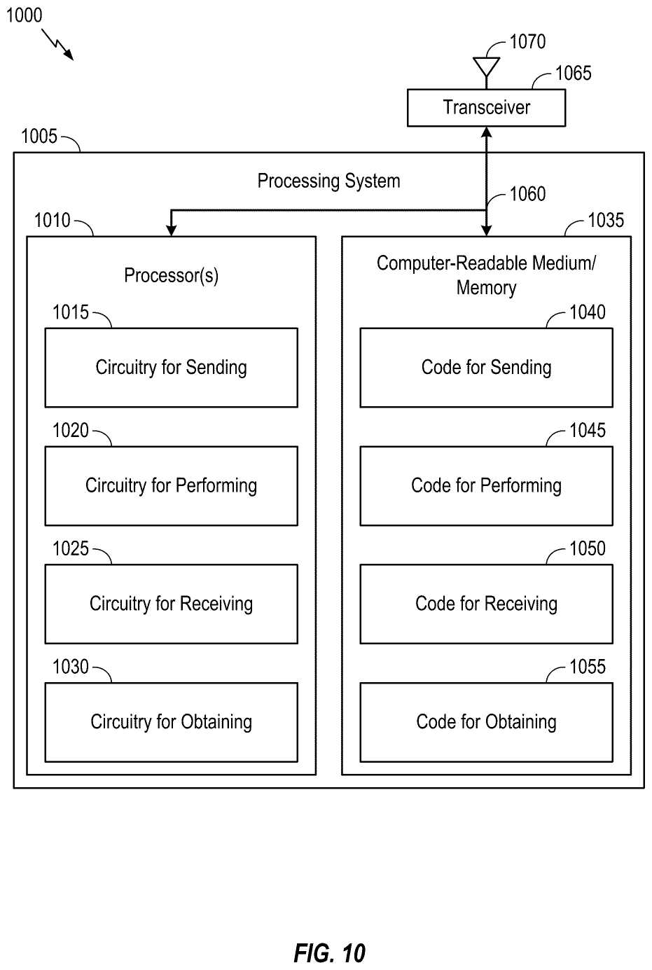

In some aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Operations of a Network Entity

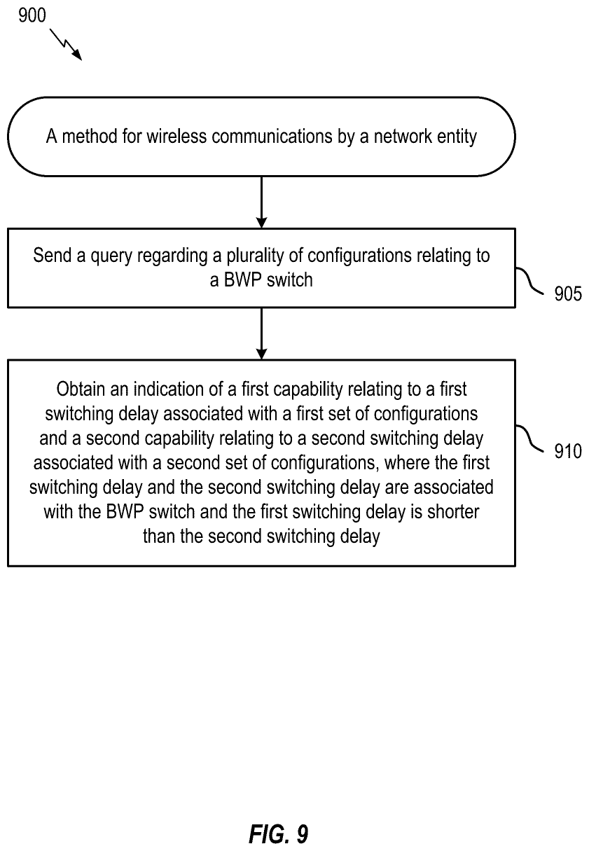

FIG. 9 shows a method 900 for wireless communications by an apparatus, such as BS 102 of FIG. 1, a first network entity 300 or second network entity 302 of FIG. 3, or a disaggregated base station as discussed with respect to FIG. 2.

Method 900 begins at block 905 with sending a query regarding a plurality of configurations relating to a BWP switch. In certain aspects, the query sent at block 905 corresponds to the query received by UE 704 at 710 of FIG. 7.

Method 900 then proceeds to block 910 with obtaining an indication of a first capability relating to a first switching delay associated with a first set of configurations and a second capability relating to a second switching delay associated with a second set of configurations, where the first switching delay and the second switching delay are associated with the BWP switch and the first switching delay is shorter than the second switching delay. In certain aspects, the indication of the first capability and the second capability obtained at block 910 corresponds to the indication of the first capability and the second capability sent by the UE 704, as described herein in connection with 706 of FIG. 7.

In certain aspects, the indication is a first indication and method 900 further includes sending a second indication of at least one configuration as a default configuration of the BWP switch.

In some aspects, the indication relates to one or more additional configurations other than the at least one configuration, where block 910 includes obtaining the indication based on the one or more additional configurations being excluded from the default configuration.

In some aspects, the indication indicates a maximum number of BWPs that can be a first BWP type, where the first BWP type is associated with the first switching delay and the second switching delay is associated with a second BWP type. In certain aspects, the method 900 further comprises sending a configuration of one or more BWPs of the first BWP type, where a number of the one or more BWPs configured as the first BWP type is less than or equal to the maximum number of BWPs indicated in the indication.

In some aspects, the configuration configures one or more other BWPs as the second BWP type, where the method 900 further comprises sending a reconfiguration of at least one BWP of the one or more BWPs of the first BWP type or the one or more other BWPs of the second BWP type by a MAC CE or a RRC signaling.

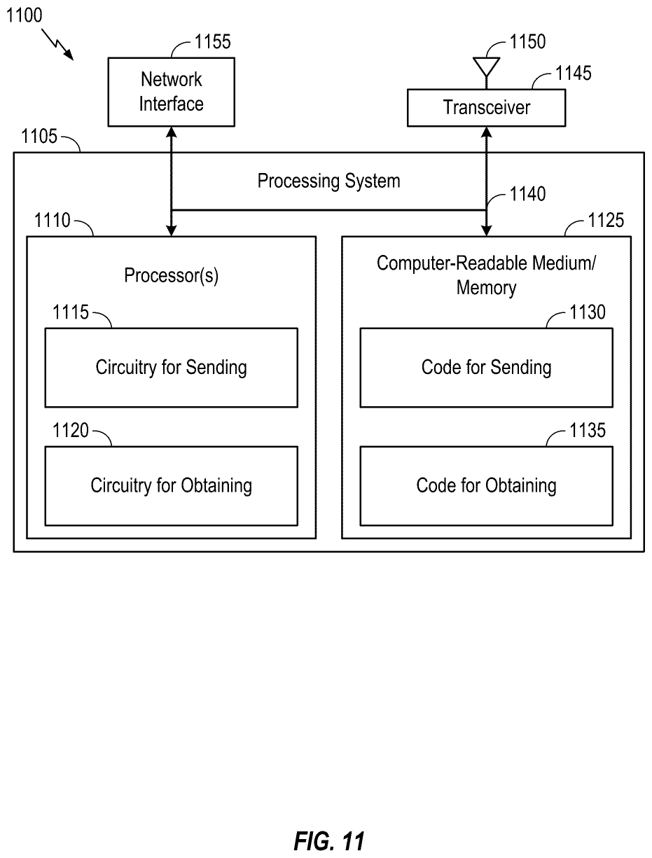

In some aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

In certain aspects, methods 800 and 900 provide the beneficial technical effects and acts as a technical solution for defining the BWP switch more precisely as described herein. For example, by defining a timeline, including a switching delay, associated with the BWP switch as a capability associated with a set of configurations (as in block 805 and block 910), the techniques described herein may enable improved wireless communications performance, such as reduced latency associated with the BWP switch, resulting in an increased data throughput.

### Example Communications Devices

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1065 (e.g., a transmitter and/or a receiver). The transceiver 1065 is configured to transmit and receive signals for the communications device 1000 via an antenna 1070, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1035. In various aspects, the one or more processors 1010 may be representative of the one or more processors 318 described with respect to FIG. 3. The one or more processors 1010 are coupled to a computer-readable medium/memory 1035 via a bus 1060. In some aspects, the computer-readable medium/memory 1035 may be representative of the one or more memories 320 described with respect to FIG. 3. The computer-readable medium/memory 1035 is a non-transitory computer-readable medium/memory. In certain aspects, the computer-readable medium/memory 1035 is configured to store instructions (e.g., computer-executable code), that when executed by the one or more processors 1010, cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1035 stores code (e.g., executable instructions), including code for sending 1040, code for performing 1045, code for receiving 1050, and code for obtaining 1055. Processing of the code 1040-1055 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1035, including circuitry for sending 1015, circuitry for performing 1020, circuitry for receiving 1025, and circuitry for obtaining 1030. Processing with circuitry 1015-1030 may enable and cause the communications device 1000 to perform the method 800 described with respect to FIG. 8, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1065 and/or antenna 1070 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1065 and/or antenna 1070 of the communications device 1000 in FIG. 10, and/or one or more processors 1010 of the communications device 1000 in FIG. 10.

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1145 (e.g., a transmitter and/or a receiver) and/or a network interface 1155. The transceiver 1145 is configured to transmit and receive signals for the communications device 1100 via an antenna 1150, such as the various signals as described herein. The network interface 1155 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1125. In various aspects, one or more processors 1110 may be representative of the one or more processors 308, as described with respect to FIG. 3. The one or more processors 1110 are coupled to the computer-readable medium/memory 1125 via a bus 1140. In certain aspects, the computer-readable medium/memory 1125 is configured to store instructions (e.g., computer-executable code), including code 1130 and 1135, that when executed by the one or more processors 1110, cause the one or more processors 1110 to perform the method 900 described with respect to FIG. 9, or any aspect related to it, including any operations described in relation to FIG. 9. The computer-readable medium/memory 1125 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1125 stores code (e.g., executable instructions), including code for sending 1130 and code for obtaining 1135. Processing of the code 1130 and 1135 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1125, including circuitry for sending 1115 and circuitry for obtaining 1120. Processing with circuitry 1115 and 1120 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1145, antenna 1150, and/or network interface 1155 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1145, antenna 1150, and/or network interface 1155 of the communications device 1100 in FIG. 11, and/or one or more processors 1110 of the communications device 1100 in FIG. 11.

### EXAMPLE CLAUSES

Implementation examples are described in the following numbered clauses:

Clause 1: A method for wireless communications by a user equipment comprising: sending, to a network entity, an indication of a first capability relating to a first switching delay associated with a first set of configurations and a second capability relating to a second switching delay associated with a second set of configurations, wherein the first switching delay and the second switching delay are associated with a BWP switch and the first switching delay is shorter than the second switching delay; and performing the BWP switch in accordance with the first switching delay or the second switching delay.

Clause 2: The method of Clause 1, further comprising: receiving, from the network entity, a query regarding a plurality of configurations; wherein sending, to the network entity, the indication comprises sending the indication in response to the query regarding the plurality of configurations.

Clause 3: The method of any one of Clauses 1-2, wherein the indication comprises a switching delay relating to one or more configurations of the first set of configurations or the second set of configurations.

Clause 4: The method of any one of Clauses 1-3, wherein the performance of the BWP switch is based on whether the BWP switch is associated with an immediate CSI feedback after the BWP switch.

Clause 5: The method of any one of Clauses 1-4, wherein the indication is a first indication and the method further comprises: sending, to the network entity, a second indication to add or remove one or more configurations to or from the BWP switch as part of at least one of a capability information or assistance information.

Clause 6: The method of any one of Clauses 1-5, wherein the indication is a first indication and the method further comprises: obtaining, from the network entity, a second indication of at least one configuration as a default configuration of the BWP switch.

Clause 7: The method of Clause 6, wherein the indication relates to one or more additional configurations other than the at least one configuration, wherein sending the indication comprises sending the indication based on the one or more additional configurations being excluded from the default configuration.

Clause 8: The method of any one of Clauses 1-7, wherein the indication indicates a maximum number of BWPs that can be a first BWP type, wherein the maximum number of BWPs are associated with the BWP switch, the first BWP type is associated with the first switching delay, and the second switching delay is associated with a second BWP type; and wherein the method further comprises obtaining a configuration of one or more BWPs of the first BWP type, wherein a number of the one or more BWPs configured as the first BWP type is less than or equal to the maximum number of BWPs indicated in the indication.

Clause 9: The method of Clause 8, wherein the configuration configures one or more other BWPs as the second BWP type; and wherein the method further comprises obtaining a reconfiguration of at least one BWP of the one or more BWPs of the first BWP type or the one or more other BWPs of the second BWP type by a MAC CE or a RRC signaling.

Clause 10: The method of any one of Clauses 8-9, wherein the indication is a first indication and the method further comprises sending a second indication of one or more parameters associated with causing a BWP to be of the first BWP type or the second BWP type, wherein the second indication is sent as part of a capability information or assistance information.

Clause 11: The method of any one of Clauses 1-10, wherein the indication is a first indication and the method further comprises: obtaining, from the network entity, a configuration of a configured number of BWPs; and sending, to the network entity, a second indication of at least a first BWP of the configured number of BWPs as being of a first BWP type or a second BWP type, wherein the first BWP type is associated with the first switching delay and the second BWP type is associated with the second switching delay.

Clause 12: The method of any one of Clauses 1-11, wherein the BWP switch comprises a change in RF bandwidth and no change in a baseband configuration.

Clause 13: A method for wireless communications by a network entity comprising: sending a query regarding a plurality of configurations relating to a BWP switch; and obtaining an indication of a first capability relating to a first switching delay associated with a first set of configurations and a second capability relating to a second switching delay associated with a second set of configurations, wherein the first switching delay and the second switching delay are associated with the BWP switch and the first switching delay is shorter than the second switching delay.

Clause 14: The method of Clause 13, wherein the indication is a first indication and the method further comprises: sending a second indication of at least one configuration as a default configuration of the BWP switch.

Clause 15: The method of Clause 14, wherein the indication relates to one or more additional configurations other than the at least one configuration, wherein obtaining the indication comprises obtaining the indication based on the one or more additional configurations being excluded from the default configuration.

Clause 16: The method of any one of Clauses 13-15, wherein the indication indicates a maximum number of BWPs that can be a first BWP type, wherein the first BWP type is associated with the first switching delay and the second switching delay is associated with a BWP second type; and wherein the method further comprises sending a configuration of one or more BWPs of the first BWP type, wherein a number of the one or more BWPs configured as the first BWP type is less than or equal to the maximum number of BWPs indicated in the indication.

Clause 17: The method of Clause 16, wherein the configuration configures one or more other BWPs as the second BWP type; and wherein the method further comprises sending a reconfiguration of at least one BWP of the one or more BWPs of the first BWP type or the one or more other BWPs of the BWP second type by a MAC CE or a RRC signaling.

Clause 18: One or more apparatuses, comprising: one or more memories comprising executable instructions; and one or more processors configured to execute the executable instructions and cause the one or more apparatuses to perform a method in accordance with any one of Clauses 1-17.

Clause 19: One or more apparatuses configured for wireless communications, comprising: one or more memories; and one or more processors, coupled to the one or more memories, configured to cause the one or more apparatuses to perform a method in accordance with any one of Clauses 1-17.

Clause 20: One or more apparatuses configured for wireless communications, comprising: one or more memories; and one or more processors, coupled to the one or more memories, configured to perform a method in accordance with any one of Clauses 1-17.

Clause 21: One or more apparatuses, comprising means for performing a method in accordance with any one of Clauses 1-17.

Clause 22: One or more non-transitory computer-readable media comprising executable instructions that, when executed by one or more processors of one or more apparatuses, cause the one or more apparatuses to perform a method in accordance with any one of Clauses 1-17.

Clause 23: One or more computer program products embodied on one or more computer-readable storage media comprising code for performing a method in accordance with any one of Clauses 1-17.

Clause 24: One or more apparatuses configured for wireless communications, comprising: a processing system that includes one or more processors and one or more memories coupled with the one or more processors, the processing system configured to cause the one or more apparatuses to perform a method in accordance with any one of Clauses 1-17.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment to:
send, to a network entity, an indication of a first capability relating to a first switching delay associated with a first set of configurations and a second capability relating to a second switching delay associated with a second set of configurations, wherein the first switching delay and the second switching delay are associated with a bandwidth part (BWP) switch and the first switching delay is shorter than the second switching delay; and
perform the BWP switch in accordance with the first switching delay or the second switching delay.

2. The apparatus of claim 1, wherein the processing system is further configured to cause the user equipment to receive, from the network entity, a query regarding a plurality of configurations; and
wherein to cause the user equipment to send, to the network entity, the indication, the processing system is configured to cause the user equipment to send the indication in response to the query regarding the plurality of configurations.

3. The apparatus of claim 1, wherein the indication comprises a switching delay relating to one or more configurations of the first set of configurations or the second set of configurations.

4. The apparatus of claim 1, wherein the performance of the BWP switch is based on whether the BWP switch is associated with an immediate channel state information (CSI) feedback after the BWP switch.

5. The apparatus of claim 1, wherein the indication is a first indication and the processing system is further configured to cause the user equipment to send, to the network entity, a second indication to add or remove one or more configurations to or from the BWP switch as part of at least one of a capability information or assistance information.

6. The apparatus of claim 1, wherein the indication is a first indication and the processing system is further configured to cause the user equipment to obtain, from the network entity, a second indication of at least one configuration as a default configuration of the BWP switch.

7. The apparatus of claim 6, wherein the indication relates to one or more additional configurations other than the at least one configuration, wherein to cause the user equipment to send the indication, the processing system is configured to cause the user equipment to send the indication based on the one or more additional configurations being excluded from the default configuration.

8. The apparatus of claim 1, wherein the indication indicates a maximum number of BWPs that can be a first BWP type, wherein the maximum number of BWPs are associated with the BWP switch, the first BWP type is associated with the first switching delay, and the second switching delay is associated with a second BWP type; and
wherein the processing system is further configured to cause the user equipment to obtain a configuration of one or more BWPs of the first BWP type, wherein a number of the one or more BWPs configured as the first BWP type is less than or equal to the maximum number of BWPs indicated in the indication.

9. The apparatus of claim 8, wherein the configuration configures one or more other BWPs as the second BWP type; and
wherein the processing system is further configured to cause the user equipment to obtain a reconfiguration of at least one BWP of the one or more BWPs of the first BWP type or the one or more other BWPs of the second BWP type by a medium access control (MAC) control element (CE) or a radio resource control (RRC) signaling.

10. The apparatus of claim 8, wherein the indication is a first indication and the processing system is further configured to cause the user equipment to send a second indication of one or more parameters associated with causing a BWP to be of the first BWP type or the second BWP type, wherein the second indication is sent as part of a capability information or assistance information.

11. The apparatus of claim 1, wherein the indication is a first indication and the processing system is further configured to cause the user equipment to:
obtain, from the network entity, a configuration of a configured number of BWPs; and
send, to the network entity, a second indication of at least a first BWP of the configured number of BWPs as being of a first BWP type or a second BWP type, wherein the first BWP type is associated with the first switching delay and the second BWP type is associated with the second switching delay.

12. The apparatus of claim 1, wherein the BWP switch comprises a change in radio frequency (RF) bandwidth and no change in a baseband configuration.

13. An apparatus for wireless communications, comprising a processing system that includes one or more processors and one or more memories coupled with the one or more processors, the processing system configured to cause a network entity to:
send a query regarding a plurality of configurations relating to a bandwidth part (BWP) switch; and
obtain an indication of a first capability relating to a first switching delay associated with a first set of configurations and a second capability relating to a second switching delay associated with a second set of configurations, wherein the first switching delay and the second switching delay are associated with the BWP switch and the first switching delay is shorter than the second switching delay.

14. The apparatus of claim 13, wherein the indication is a first indication and the processing system is further configured to cause the network entity to send a second indication of at least one configuration as a default configuration of the BWP switch.

15. The apparatus of claim 14, wherein the indication relates to one or more additional configurations other than the at least one configuration, wherein to cause the network entity to obtain the indication, the processing system is configured to cause the network entity to obtain the indication based on the one or more additional configurations being excluded from the default configuration.

16. The apparatus of claim 13, wherein the indication indicates a maximum number of BWPs that can be a first BWP type, wherein the first BWP type is associated with the first switching delay and the second switching delay is associated with a second BWP type; and
wherein the processing system is further configured to cause the network entity to send a configuration of one or more BWPs of the first BWP type, wherein a number of the one or more BWPs configured as the first BWP type is less than or equal to the maximum number of BWPs indicated in the indication.

17. The apparatus of claim 16, wherein the configuration configures one or more other BWPs as the second BWP type; and
wherein the processing system is further configured to cause the network entity to send a reconfiguration of at least one BWP of the one or more BWPs of the first BWP type or the one or more other BWPs of the second BWP type by a medium access control (MAC) control element (CE) or a radio resource control (RRC) signaling.

18. A method for wireless communications by a user equipment comprising:
sending, to a network entity, an indication of a first capability relating to a first switching delay associated with a first set of configurations and a second capability relating to a second switching delay associated with a second set of configurations, wherein the first switching delay and the second switching delay are associated with a bandwidth part (BWP) switch and the first switching delay is shorter than the second switching delay; and
performing the BWP switch in accordance with the first switching delay or the second switching delay.

19. The method of claim 18, further comprising:
receiving, from the network entity, a query regarding a plurality of configurations; and
wherein sending, to the network entity, the indication comprises sending the indication in response to the query regarding the plurality of configurations.

20. The method of claim 18, wherein the indication comprises a switching delay relating to one or more configurations of the first set of configurations or the second set of configurations.

21. The method of claim 18, wherein the indication is a first indication and the method further comprises:
sending, to the network entity, a second indication to add or remove one or more configurations to or from the BWP switch as part of at least one of a capability information or assistance information.

22. The method of claim 18, wherein the indication is a first indication and the method further comprises:
obtaining, from the network entity, a second indication of at least one configuration as a default configuration of the BWP switch.

23. The method of claim 22, wherein the indication relates to one or more additional configurations other than the at least one configuration, wherein sending the indication comprises sending the indication based on the one or more additional configurations being excluded from the default configuration.

24. The method of claim 18, wherein the indication indicates a maximum number of BWPs that can be a first BWP type, wherein the maximum number of BWPs are associated with the BWP switch, the first BWP type is associated with the first switching delay, and the second switching delay is associated with a second BWP type; and
wherein the method further comprises obtaining a configuration of one or more BWPs of the first BWP type, wherein a number of the one or more BWPs configured as the first BWP type is less than or equal to the maximum number of BWPs indicated in the indication.

25. The method of claim 24, wherein the configuration configures one or more other BWPs as the second BWP type; and
wherein the method further comprises obtaining a reconfiguration of at least one BWP of the one or more BWPs of the first BWP type or the one or more other BWPs of the second BWP type by a medium access control (MAC) control element (CE) or a radio resource control (RRC) signaling.

26. The method of claim 24, wherein the indication is a first indication and the method further comprises sending a second indication of one or more parameters associated with causing a BWP to be of the first BWP type or the second BWP type, wherein the second indication is sent as part of a capability information or assistance information.

27. The method of claim 18, wherein the indication is a first indication and the method further comprises:
obtaining, from the network entity, a configuration of a configured number of BWPs; and
sending, to the network entity, a second indication of at least a first BWP of the configured number of BWPs as being of a first BWP type or a second BWP type, wherein the first BWP type is associated with the first switching delay and the second BWP type is associated with the second switching delay.

28. A method for wireless communications by a network entity comprising:
sending a query regarding a plurality of configurations relating to a bandwidth part (BWP) switch; and
obtaining an indication of a first capability relating to a first switching delay associated with a first set of configurations and a second capability relating to a second switching delay associated with a second set of configurations, wherein the first switching delay and the second switching delay are associated with the BWP switch and the first switching delay is shorter than the second switching delay.

29. The method of claim 28, wherein the indication is a first indication and the method further comprises:
sending a second indication of at least one configuration as a default configuration of the BWP switch,
wherein the indication relates to one or more additional configurations other than the at least one configuration, wherein obtaining the indication comprises obtaining the indication based on the one or more additional configurations being excluded from the default configuration.

30. The method of claim 28, wherein the indication indicates a maximum number of BWPs that can be a first BWP type, wherein the first BWP type is associated with the first switching delay and the second switching delay is associated with a second BWP type;
wherein the method further comprises sending a configuration of one or more BWPs of the first BWP type, wherein a number of the one or more BWPs configured as the first BWP type is less than or equal to the maximum number of BWPs indicated in the indication,
wherein the configuration configures one or more other BWPs as the second BWP type; and
wherein the method further comprises sending a reconfiguration of at least one BWP of the one or more BWPs of the first BWP type or the one or more other BWPs of the second BWP type by a medium access control (MAC) control element (CE) or a radio resource control (RRC) signaling.
